(19) United States
(12) Patent Application Publication
(10) Pub. No.: US 2008/0083672 A1
(43) Pub. Date: Apr. 10, 2008

(54) ADSORBENT COMPOSITION AND METHOD OF MAKING SAME

(76) Inventors: Xing Dong, Chattanooga, TN (US); Henry Paris, Chattanooga, TN (US)

Correspondence Address: W. EDWARD RAMAGE, COMMERCE CENTER SUITE 1000, 211 COMMERCE ST, NASHVILLE, TN, 37201, US

(21) Appl. No.: 11/870,254

(22) Filed: Oct. 10, 2007

Related U.S. Application Data
(60) Provisional application No. 60/828,824, filed on Oct. 10, 2006.

(51) Int. Cl. C02F 1/42; C01B 33/12

(52) U.S. Cl. 210/660; 423/335; 502/235

(57) ABSTRACT

An adsorbent is made by chemically attaching proper functional groups onto low cost precipitated silica surface under elevated temperature and pressure conditions. Functional groups are designed for particular targeted compounds. The resulting adsorbent has low production cost, high capacity and fast kinetics for adsorption applications. The resulting adsorbent also is very effective in adsorbing heavy metals such as mercury in high pH solutions.

This application claims benefit of, and priority to, U.S. Provisional Patent Application No. 60/828,824, filed Oct. 10, 2006, by Xing Dong, et al., entitled “AN ADSORBENT COMPOSITION AND METHOD OF MAKING SAME.” The specification, drawings, and complete disclosure of U.S. Provisional Patent Application No. 60/828,824 are incorporated herein by specific reference.

### TECHNICAL FIELD

This invention relates to a novel adsorbent for adsorption applications, and the method of preparing such an adsorbent.

### BACKGROUND OF THE INVENTION

A few metals, such as arsenic, beryllium, lead, cadmium, chromium, mercury and barium are toxic to humans and animals. Air, wastewater and natural waters may contain a variety of toxic metal compounds from natural and anthropogenic sources. For protection of public health and of environmental quality, regulatory limits for those toxic compounds in air, drink water, and for discharge to natural waters have been set at low levels—1.3 parts per trillion (1.3 ng/L) of mercury for the Great Lakes drainage basin, for example.

In order to meet various regulatory limits, extensive research has been conducted in recent years regarding the development of heavy metal treatment methods, and the synthesis of rationally designed materials capable of specifically removing heavy metals. These methods include amalgam formation using silver or gold, adsorption on activated carbon, sulfur and halogen doped carbon, adsorption on ion-exchange material, colloid precipitation, and adsorption on resins having immobilized chelating groups.

However, the slow kinetics, low toxic metal loading capacity, and high production cost of these materials make the heavy metal removal process expensive and less efficient. For example, although heavy metal amalgams, such as a mercury amalgam, can be formed on silver or gold, this method is very expensive due to the high cost of material, which essentially excludes its wide use in industry.

Similarly, the adsorption of heavy metals on activated and halogen-treated carbon is one of the most studied methods, and has been used in coal-fired power plants. U.S. Pat. No. 5,672,323 discloses the injection of activated carbon to the flue gas to remove mercury. The effectiveness of carbon injection for mercury control is limited, however, by adsorbent capacity and flue gas interactions with the activated carbon. In general, the slow kinetics, the large required quantity of carbon, and the nature of adsorption raise significant problems.

Ion-exchange resin is a well-known commercial product. U.S. Pat. No. 4,883,599 discloses a method using a sulfhydrated cellulose ion-exchange material to clean heavy metal contaminated solutions. However, using ion exchange resin to reduce the heavy metal concentrations to the mandated low regulatory levels requires the use of extremely large adsorbent columns due to the slow heavy metal removal kinetics and low capacity. The cost of building and operating such a system increase with the size of the system, often rendering it uneconomical.

Extensive research also has been conducted using organic/inorganic hybrid materials, which are made by chemically mixing or attaching heavy metal binding ligand in/onto inorganic support. Porous silica is a class of materials that fulfils this purpose. Silica has surface silanol groups, which can function as anchoring groups for variety chemicals via surface chemical reactions. Silica is widely and abundantly available. It exists in two varieties, amorphous and crystalline. In its amorphous state, silica does not have a regular lattice pattern in the structure. In contrast, in its crystalline form, silica has a long-range regular lattice pattern, characterized by tetrahedral configuration of atoms in the crystals.

There are several types of silica, such as fumed silica, precipitated silica, silica gel, and colloidal silica, manufactured by different methods. For instance, precipitated silica is prepared by neutralizing a solution of sodium silicate with an acid, e.g., sulfuric acid. Then the sodium sulfate is filtrated out as by-product and the remaining silica is dried and calcinated and/or milled for the final product. The preparation parameters such as the concentration of sodium silicate, the ratio of reactants, reaction time, drying temperature, and the calcination temperature affect the final product physical properties, such as specific surface area, pore size, pore shape, pore volume, and particle morphology, as well as chemical properties, such as silanol group density, point of zero charge value, and the like.

More recently, a new family of silica called M41S, an ordered mesoporous silica, was developed by Mobil Oil scientists in 1992. MCM-41 is one of members of this family and has been extensively studied in many applications, including adsorbents. MCM-41 has a hexagonal array of relative uniform pores, which ranges from 15 Å to 100 Å. It has specific surface area about 700 to over 1000 m²/g. The synthesis of larger porous silica like MCM-41 is a major breakthrough in the history of development of porous materials since increasing the pore size permits the penetration of large size molecules into the host porous structure and results in improved mass transport. This is a central point for any processes concerning accessibility, such as catalysis, sorption, or sensors.

M41S is prepared by a templating method using supramolecular assemblies, which are micellar systems formed by surfactants or block copolymers. In general, the first step is to form supramolecular templates and then a silica source such as tetraethylorthosilicate is introduced to form a framework of silica. After an extended aging process, the solids are collected and washed using filtration method. In the end, the surfactants or block copolymers are removed by calcination of M41S precursor at high temperature.

Though this family of silica has been found very useful in many applications, the complicated and lengthy processing procedure as well as the expensive block copolymers prevent it wide use, especially in cases where the cost is one of major driving forces. This is especially true for heavy metal adsorption applications. Although ordered mesoporous silica materials treated with thiol groups have shown extraordinary promise for heavy metal treatment (especially mercury), practical industrial applications have not been developed. For example, studies have reported that the thiol-functionalized ordered mesoporous silica adsorbent has a mercury adsorption capacity as high as 1.5 mmol/g. One laboratory study synthesized a thiol functionalized MCM-41 as an adsorbent and reported an even higher mercury adsorption capacity of 2.5 mmol/g. However, the production cost of these functionalized ordered mesoporous adsorbents is relatively high due to the complicated and lengthy production process, the high cost of making mesoporous silica, and the high cost of the thiol-contained precursor to functionalize the mesoporous silica.

Attempts have been made to overcome some of these problems. One recent study used a relatively low cost material (pillared clay minerals) to replace expensive ordered mesoporous silica, but found that the mercury removal capacity decreased from 1.5 mmol/g to 0.74 mmol/g, and that only up to 67% of the immobilized thiol groups on the pillared clay minerals were accessible to mercury. As an indicator of mercury adsorption efficiency, the fraction of surface attached ligand bonded to metal ion (φ) is calculated by the equation:
φ=N_{f}/Lo

where

Lo=millimoles of ligand per gram of functionalized silica

N_{f}=(nᵢ−nₑ)/m, where nᵢ is the initial number of moles of mercury added to the system, nₑ the amount remaining after the equilibrium, and m is the mass in grams of the adsorbent.

Of great importance is the fact that adsorption kinetics is one of the key parameters determining adsorption process and its cost. Slow kinetics, as with some ion exchange resins, requires larger adsorbent columns or larger reactors, which results in higher costs to build, operate and maintain such an adsorption system.

One recent study prepared an adsorbent in one step synthesis by co-condensation of tetraethylorthosilicate and 3-mercaptopropyltrimethoxysilane (3-MPTMS) using non-ionic surfactants. Though high efficiency and high mercury adsorption capacity (2.3 mmol/g) were achieved, the cost to make such an adsorbent was still high, resulting from the complicated synthesis procedure and lengthy processing time. Another study developed a method to make thiol-functionalized MCM-41 by replacing the toxic organic solvent with supercritical carbon dioxide (as disclosed in U.S. Pat. No. 6,846,554). This new method not only reduced the processing time to prepare thiol-functionalized MCM-41, but also increased the thiol functional group density on the surface of MCM-41. The cost to make functionalized ordered mesoporous adsorbent, however, is still high, and the mercury adsorption properties were not examined. The patent lacks to provide any mercury adsorption data, although the authors assume the new functionalized materials may have improved mercury adsorption property.

Accordingly, none of adsorbents made in accordance with the known prior art are able to cost-effectively adsorb heavy metals from fluids with high loading capacity and fast adsorption kinetics.

Another important aspect of adsorbents has not been addressed well is their functionality in high pH solutions. Mercury emission from chlor-alkali plants using electronic mercury cells is one of the major mercury sources, where the pH of waste streams is generally higher than 10. The pH of the aqueous solution is one of the important controlling parameters in the adsorption process. None of adsorbents made according to the known prior art is effective in adsorbing heavy metal species, especially mercury, at a pH of higher than 10.

Accordingly, there exists a continuing need for adsorbents which are economical and of practical value. For example, the purity of NaOH produced in chlor-alkali cells for synthesis of high purity carbonates is important for use in pharmaceutical chemicals and glass making. The present invention is innovatively different from what has been known in prior art in its ability to adsorb metals in high pH solutions, with a high adsorption loading capacity and fast kinetics for heavy metal adsorption (particularly for mercury), at a low cost.

### SUMMARY OF THE INVENTION

This invention is directed to an adsorbent and related method of production. The adsorbent is able to adsorb targeted compounds in high pH conditions, can be manufactured at relatively low cost, has high capacity, and fast kinetics for heavy metal adsorption.

In one exemplary embodiment, the adsorbent composition has a specific surface area of at least 200 m²/g, a pore volume at least 0.8 ml/g, an average pore diameter of at least 100 Å, and also possessing macropores (macropores are pores with diameters larger than 500 Å). The composition comprises silica having the surface chemically attached with a functional group which are able to adsorb the targeted compound chemically. The functional groups are attached onto the silica under a pressure of at least 2000 psi.

In an exemplary embodiment, the adsorbent described herein functions well in high pH solutions. Another advantage of the adsorbent described herein is that the overall production cost is lowered significantly. Cost savings can be realized as a result of the low cost of the several different approaches to produce such an adsorbent. In particular, costs savings are realized through the reduction in the cost of raw material and the method to make such an adsorbent. Another advantage of the adsorbent described herein are the fast adsorption kinetics, which in turn increases the adsorbent turnover frequency and reduces the cost to build, operate and maintain the adsorption systems.

Another embodiment of the present invention comprises a method to manufacture a low cost adsorbent having high capacity and fast kinetics. More specially, the production process produces a low cost adsorbent having high capacity, fast kinetics, and able to adsorb metals in high pH solutions.

The low cost is achieved by the selection of low cost raw materials and implementation of a cost-effective preparation method. Raw material selection and mass production reduce overall production costs significantly.

The method of the present invention can be adjusted to optimize the characteristics of the adsorbent produced. This adjustment may be achieved by developing and tuning reaction conditions, including, but not limited to, the reaction temperature ramp rate, the targeted reaction temperature, reaction time, the ratio of reactants, the hydration percentage, the extraction flow rate, the extraction time, the pressurizing time, the flow direction, and the raw material introduction method.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a diagram of a method for producing an adsorbent in accordance with an exemplary embodiment of the present invention.

FIG. 2 is a diagram of an alternative method for producing an adsorbent in accordance with another exemplary embodiment of the present invention.

FIG. 3 is a graph showing BET surface area of bare silica.

FIG. 4 is a graph showing the nitrogen adsorption/desorption isotherm curve.

FIG. 5 is a graph depicting pore size distribution of bare silica.

FIG. 6 is a graph depicting particle size distribution of bare silica.

FIG. 7 is a graph showing the morphology of bare silica using a scanning electron microscope.

FIG. 8 is a graph showing a thermal gravimetric analysis of hydrated silica.

FIG. 9 is a graph depicting the adsorbent mercury adsorption kinetics.

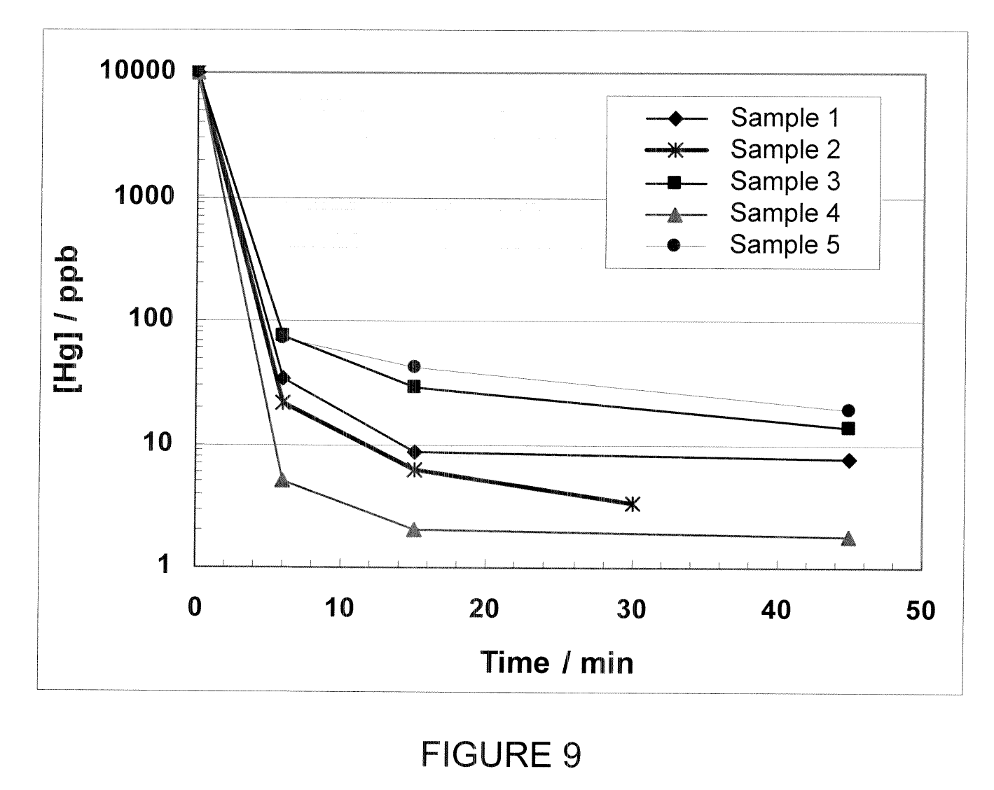

FIG. 10 is a graph showing the ability of adsorbents in adsorbing mercury in high pH solutions.

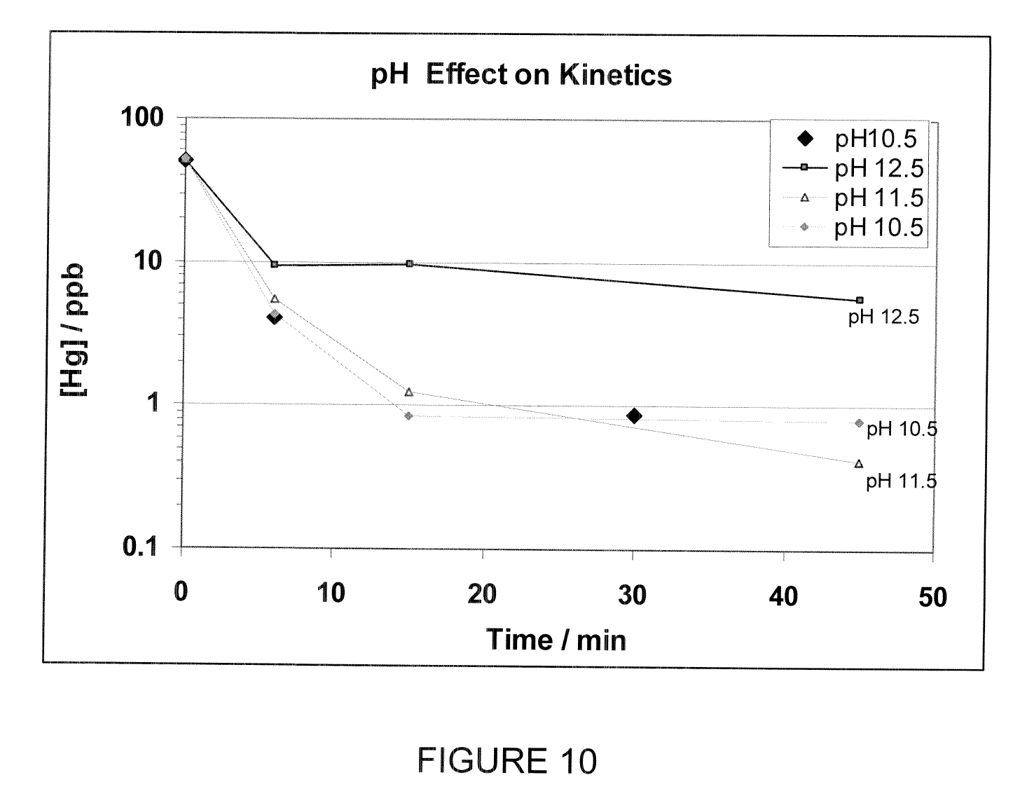

### DETAILED DESCRIPTION OF EXEMPLARY EMBODIMENTS

Disclosed herein is an adsorbent for use in heavy metal adsorption applications. In an exemplary embodiment, the adsorbent has a low production cost, high capacity, fast kinetics and functionality in high pH solutions (i.e., a pH higher than 10), particularly for mercury adsorption.

In one embodiment, the present invention comprises an adsorbent support with an attached functional group. In an exemplary embodiment, the invention uses low-cost precipitated silica as the adsorbent support. The price of precipitated silica ranges from 1/30 to ⅙ the cost more expensive, synthetic, ordered-mesoporous silica. For example, at present, the price of such precipitated silica ranges from $1/lb to $5/lb depending on the vendor and the precipitated silica specifications, as compared with over $30/lb for synthetic ordered-mesoporous silica such as MCM-41.

The physical properties of precipitated silica such as specific surface area, pore size, pore shape, pore volume, and particle morphology, as well as chemical properties such as silanol group density, point of zero charge value can be varied during production by varying reaction parameters. Preferably, the average pore size is larger than 100 Å, and more preferably larger than 150 Å. The specific surface area is preferably larger than 200 m²/g, more preferably larger than 300 m²/g, and most preferably larger than 400 m²/g. The pore volume is preferably larger than 0.3 ml/g, more preferably larger than 0.4 ml/g, and most preferably larger than 0.8 ml/g. The pore shape is preferably of no narrow neck. For liquid filtration applications, the particle size is preferably larger than 5 microns, more preferably larger than 10 microns, and most preferably larger than 15 microns. For gas applications, the particle size is preferably smaller than 2 microns, more preferably smaller than 1 micron and most preferably smaller than 0.5 micron for removing heavy metals.

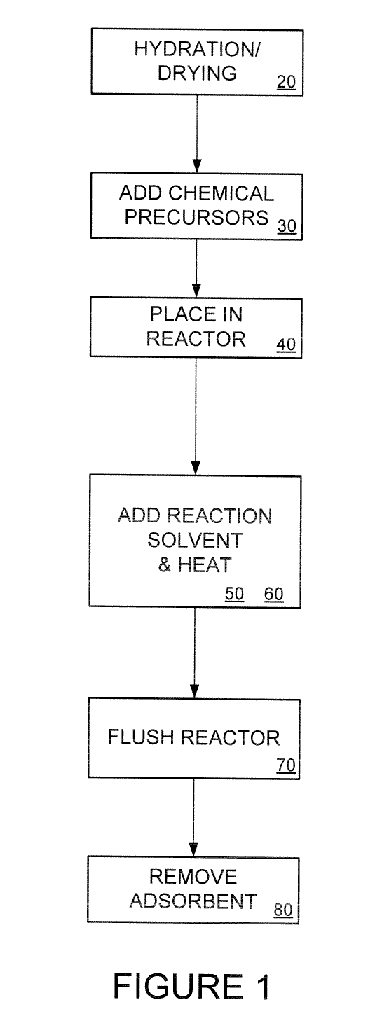

As shown in FIG. 1, the precipitated silica is subjected to hydration or drying 20 at elevated temperature to control the surface silanol group density. In cases where the hydrophobicity/hydrophilicity is not a key concern, 100% of the surface silicon may be hydrated. In cases where the hydrophobicity/hydrophilicity has an effect on adsorbent properties, the surface silanol group density can be tuned by single or multiple hydration/drying steps. Hydration may be performed in a passive humidifier chamber, where the temperature and humidity are controlled. The degree of hydration may be monitored by weight gain during hydration and confirmed by thermal gravimetric analysis. In one particular embodiment, no more than two monolayers of water should be added onto silica surface. Hydration may be also performed by mixing the silica in boiling water for a certain period, such as one hour. Subsequently, the silica is filtrated and dried under elevated temperature to control the degree of hydration by removing excess amounts of water on the silica surface. The drying process may be performed in an oven with or without a material mixing function. One practical way to control the drying step is to monitor the weight change and further confirmed by thermal gravimetric analysis of the dried silica to precisely monitor and control the water content in silica.

The hydrated silica then is mixed with chemical precursors 30 containing one or more proper functional groups for a desired application. For example, if the adsorbent is designed for mercury adsorption, then the chemical precursor may be one containing thiol functional groups, such as 3-mercaptopropyltrimethoxysilane. The appropriate amount of chemical precursor may be determined by the specific surface area of silica and the adsorbent design criterions. For example, if the specific surface area of silica is 500 m²/g and the targeted surface functional group coverage is 100%, then the required ratio of 3-mercaptopropyltrimethoxysilane to silica would be 0.82. Preferably, a little excess amount of chemical precursors may be introduced in order to ensure that the targeted surface functional group coverage is obtained.

The mixture is then placed in a high-pressure reactor 40, which either may have been pre-heated to a desired temperature or may just remain at room temperature. The reactor is then sealed and heated to a required reaction temperature 50, depending on the chemical precursor used. For example, in the case where 3-mercaptopropyltrimethoxysilane is the chemical precursor, the reaction temperature preferably is higher than around 90° C., more preferably higher than around 110° C., and most preferably higher than around 130° C. In the meantime, the reactor is charged with a reaction solvent 60, such as carbon dioxide or nitrogen, to a certain pressure. The pressure is at least higher than around 2000 psi, preferably higher than around 3000 psi, more preferably higher than around 5000 psi, and most preferably higher than around 7000 psi.

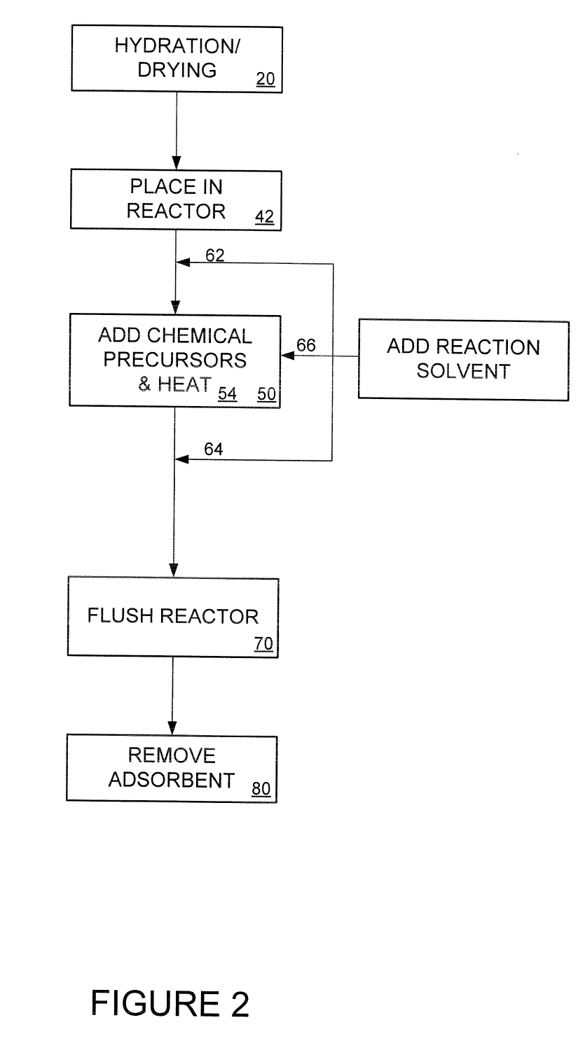

As shown in FIG. 2, an alternative way to introduce the chemical precursors and high-pressure reaction solvent (e.g., carbon dioxide) is described as follows: The hydrated silica is placed in the high-pressure reactor 42, which either has been pre-heated to the desired temperature or just remains the room temperature. The reactor is then sealed and may be heated to required reaction temperature 52. The chemical precursors are then delivered to the reactor using a high-pressure pump 54. The reaction solvent (e.g., carbon dioxide) may be charged into the reactor either before the chemical precursors are delivered 62, or after chemical precursors are delivered 64, or at the same time the chemical precursors are delivered into the reactor 66.

The reactor may or may not be equipped with an internal mixing apparatus. The reaction time is preferably longer than 5 minutes, more preferably longer than 10 minutes, and most preferably longer than 20 minutes. After the reaction time has passed, the by-products and any non-reacted chemical precursors are moved by dynamically flushing the reactor 70 with high-pressure carbon dioxide (or a similar gas) for a certain period until no by-products and other chemicals are detected. The reactor pressure is then released and the resulting adsorbent comprising a functional group (or groups) grafted onto silica is removed 80 from the reactor as the final product.

In accordance with an embodiment of the present invention, the resulting adsorbents have a high metal adsorption capacity, especially for mercury adsorption. Preferably, the adsorption capacity of adsorbent is larger than 0.2 g Hg/g adsorbent, more preferably larger than 0.3 g Hg/g adsorbent, and most preferably higher than 0.4 g Hg/g adsorbent.

The resulting adsorbents also have fast adsorption kinetics. Preferably, 98% of the mercury is adsorbed within six minutes, more preferably 99% of the mercury is adsorbed within six minutes, and most preferably 99.9% of the mercury is adsorbed within six minutes.

In yet another embodiment of the present invention, the resulting adsorbents are effective in adsorbing mercury in high pH solutions. Preferably, the resulting adsorbents are able to adsorb 99% mercury within six minutes at pH of higher than 10, more preferably, the resulting adsorbents are able to adsorb 99% mercury within six minutes at pH of higher than 11, and most preferably, the resulting adsorbents are able to adsorb 99% mercury within six minutes at pH of 12.

While several embodiments of the present invention have been described, it is to be understood that the present invention is not limited to the above-described embodiments, but various changes and modifications may be made without departing from the spirit and scope of the invention. The present invention is further illustrated by the following samples and tests. However, these examples are not to be construed to limit the scope of the invention.

Sample 1

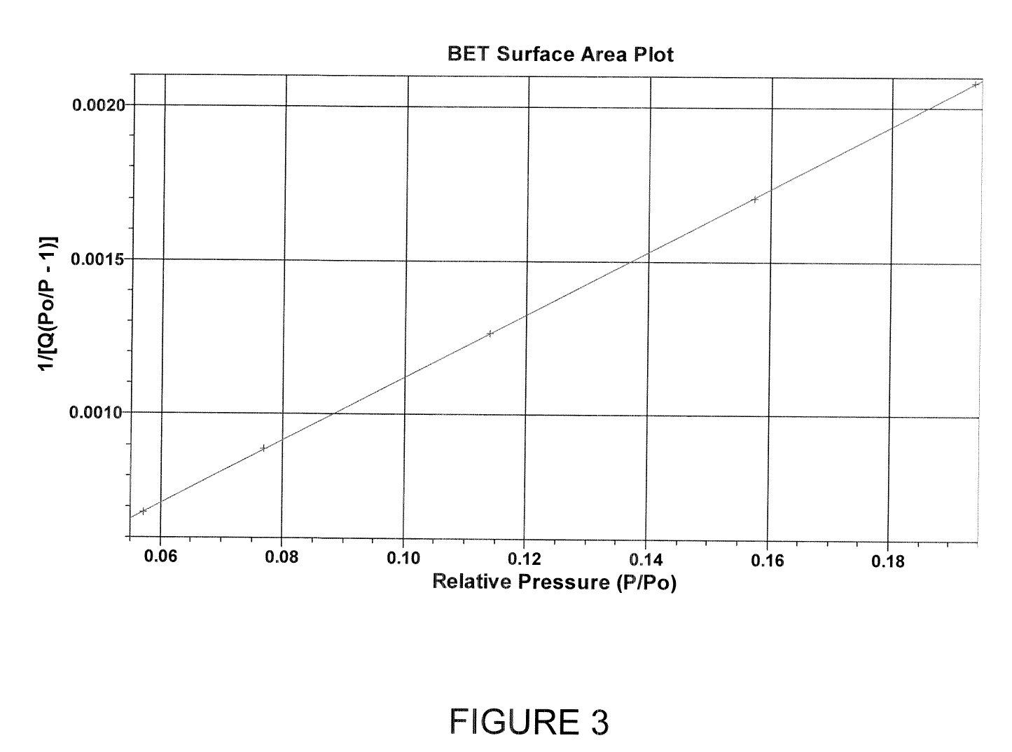

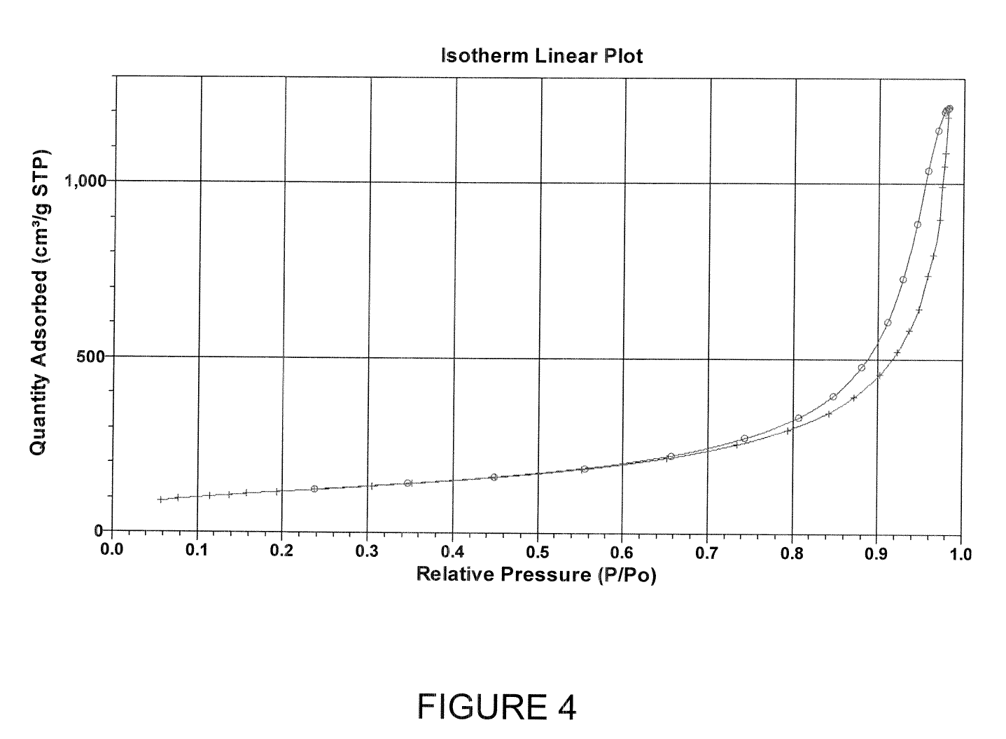

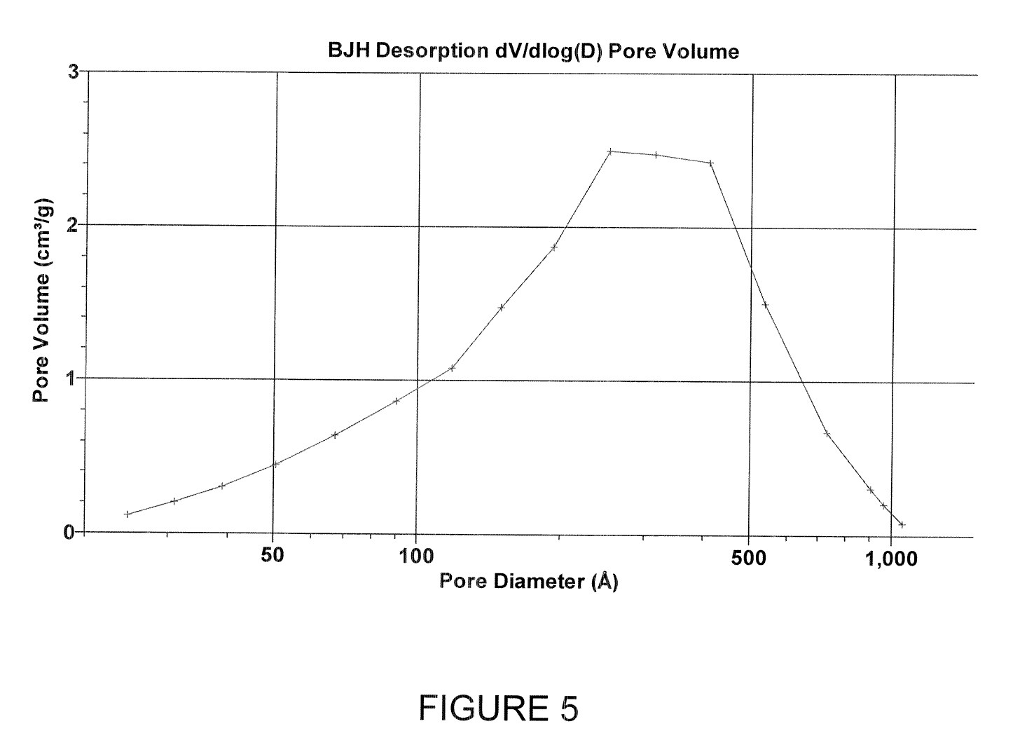

Supernat® 50 silica purchased from Degussa (Parsippany, N.J.) was used as the support. The silica has a BET surface area of 421 m²/g, as derived from FIG. 3. The silica has an average pore size of 179 Å, a pore volume of 1.8 ml/g, and particle size of 29 um (d₅₀), as indicated in FIGS. 4-6. The nitrogen adsorption/desorption isotherm curve (FIG. 2) indicates the presence of macropores, which is confirmed by pore size distribution curve (FIG. 3). The SEM shows its morphology is nearly spherical (FIG. 5).

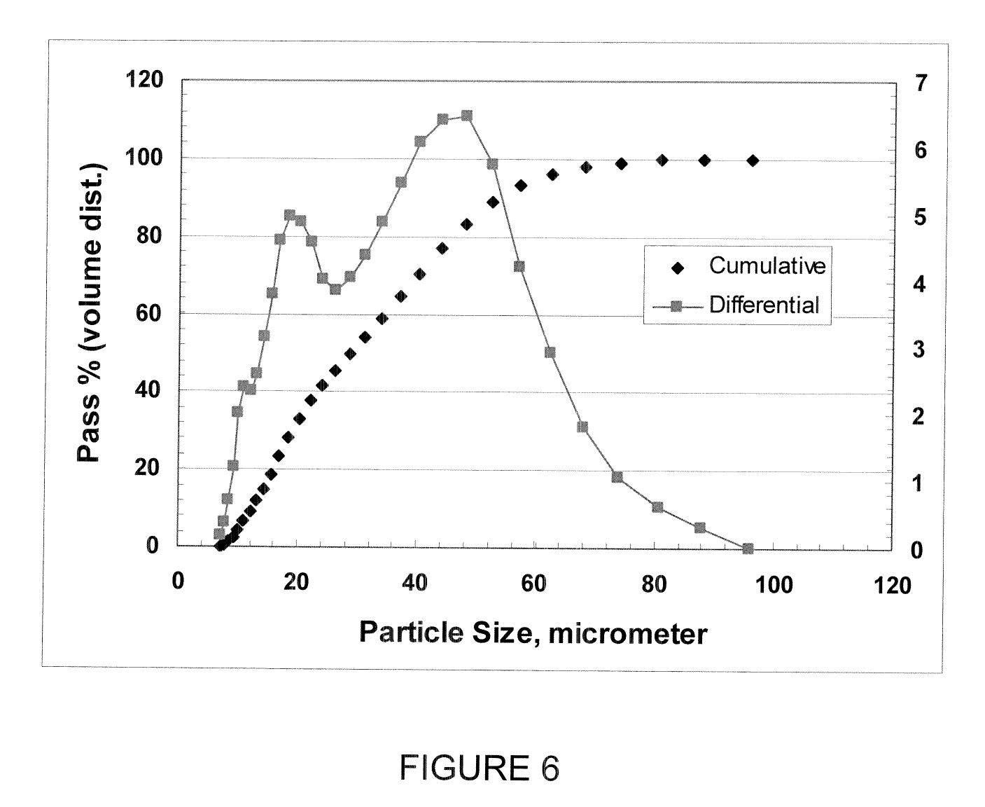

480 grams of the Supernat® 50 precipitated silica was placed in a humidifier chamber at temperature of 80° C. and relative humidity of 90%. After 3 hours, the hydrated silica was taken out and analyzed using a thermal gravimetric instrument. As shown in FIG. 6, the water content was about 12%.

538 grams of hydrated silica, prepared following the above procedure, was then mixed with 302 grams of 3-MPTMS (the chemical precursor). The mixture was then transferred to a high-pressure reactor, which had been pre-heated to 145° C. Carbon dioxide (the reaction solvent) was subsequently charged to the sealed reactor using a high-pressure pump. The pressure was adjusted to 7500 psi. After 30 minutes reaction time, the by-products and un-reacted 3-MPTMS were extracted using a dynamic flow of carbon dioxide at a rate about 180 cc/min for about 1.5 hours. The reactor pressure was then released and the samples were taken out as final product. The final product's BET surface area decreased from 421 m²/g to 165 m²/g as result of attachment of functional groups onto silica surface.

Sample 2

342 grams of hydrated silica were prepared according to the above procedure, except the water content was adjusted to 14%. The silica was mixed with 299 grams of 3-MPTMS. The mixture was then transferred to a high-pressure reactor, which had been pre-heated to 150° C. Carbon dioxide was subsequently charged to the sealed reactor using a high-pressure pump. The pressure was adjusted to 7500 psi. After 30 minutes' reaction, the by-products and un-reacted 3-MPTMS were extracted using a dynamic flow of carbon dioxide at a rate about 150 cc/min for about 1.5 hours. The reactor pressure was then released and the samples were taken out as final product. Final product BET surface area was 115 m²/g.

Sample 3

547 grams of hydrated silica, as prepared following the procedure in Sample 1 except the water content was adjusted to 14%, was mixed with 403 grams of 3-MPTMS. The mixture was then transferred to a high-pressure reactor, which had been pre-heated to 155° C. Carbon dioxide was subsequently charged to the sealed reactor using a high-pressure pump. The pressure was adjusted to 7500 psi. After 30 minutes' reaction, the by-products and un-reacted 3-MPTMS were extracted using a dynamic flow of carbon dioxide at a rate about 180 cc/min for about 1.5 hours. The reactor pressure was then released and the samples were taken out as final product, which had a BET surface area of 123 m²/g.

Sample 4

480 grams of hydrated silica, as prepared following the procedure in Sample 1 except the water content was adjusted to 14%, was mixed with 302 grams of 3-MPTMS. The mixture was then transferred to a high-pressure reactor, which had been pre-heated to 145° C. Carbon dioxide was subsequently charged to the sealed reactor using a high-pressure pump. The pressure was adjusted to 7500 psi. After 35 minutes' reaction, the by-product and un-reacted 3-MPTMS were extracted using a dynamic flow of carbon dioxide at a rate about 150 cc/min for about 1.5 hours. The reactor pressure was then released and the samples were taken out as final product. The final product had a BET surface area of 171 m²/g.

Sample 5

480 grams of hydrated silica, as prepared following the procedure in Sample 1, was mixed with 302 grams of 3-MPTMS. The mixture was then transferred to a high-pressure reactor, which had been pre-heated to 145° C. Carbon dioxide was subsequently charged to the sealed reactor using a high-pressure pump. The pressure was adjusted to 7500 psi. After 30 minutes' reaction, the by-products and un-reacted 3-MPTMS were extracted using a dynamic flow of carbon dioxide at a rate about 180 cc/min for about 1.5 hours. The reactor pressure was then released and the samples were taken out as final products. The final adsorbent had a BET surface area of 201 m²/g.

The mercury capacity tests of the adsorbents produced above as Samples 1-5 were tested as follows: A mercury contact solution was made using 0.1M NaNO₃ solution spiked with approximately 200 ppm Hg of Hg(NO₃)₂. Subsequently, an adsorbent prepared in accordance with the present invention was added to the prepared mercury contact solution with a solution-to-solid ratio of 5000 ml/g. The solution then was stirred for 24 hours in order to equilibrate the mixtures. An aliquot of solution was then taken out and subject to filtration using a 0.2 μm syringe filter. The mercury concentration after the adsorption was analyzed using a Cold Vapor Atomic Fluorescence Adsorption analytical method or any other suitable methods.

All samples show a mercury adsorption capacity higher than 0.4 g Hg/g adsorbent. The results of the testing are showed in the following table:

TABLE 1
Mercury Adsorption Capacity Results

| Sample | Capacity (g Hg/g adsorbent) |
|---|---|
| Sample 1 | 0.51 |
| Sample 2 | 0.65 |
| Sample 3 | 0.49 |
| Sample 4 | 0.44 |
| Sample 5 | 0.41 |

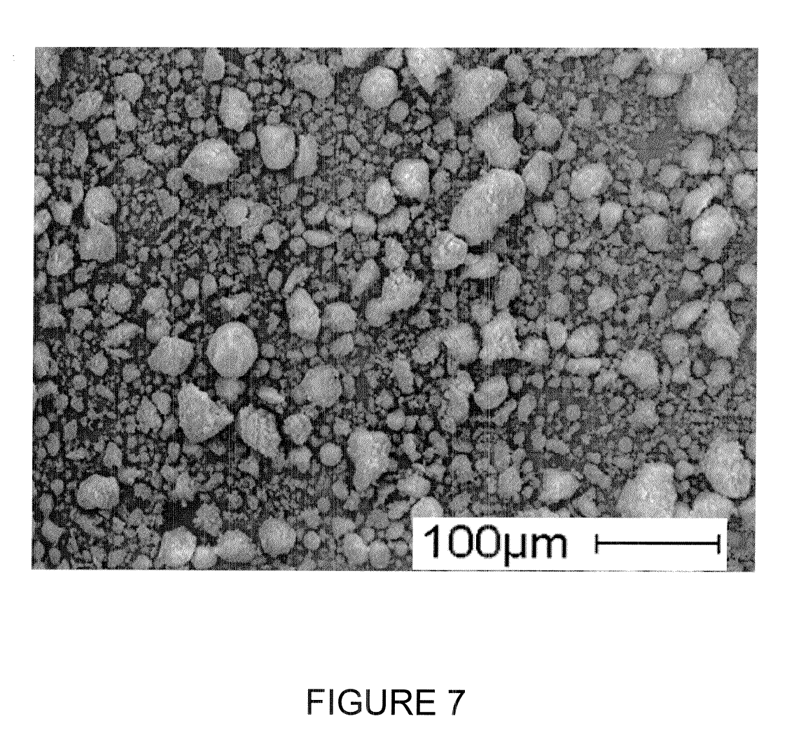

The mercury adsorption kinetics of the five samples were tested as follows: A mercury contact solution was made using 0.1M NaNO₃ solution spiked with approximately 10 ppm Hg of Hg(NO₃)₂. An adsorbent was added to the prepared mercury contact solution with a solution-to-solid ratio of 2000 ml/g. A portion of the solution was then taken out periodically and subject to filtration using a 0.2 μm syringe filter. The mercury concentrations after the adsorption were analyzed using a Cold Vapor Atomic Fluorescence Adsorption analytical method or any other suitable methods. As shown in FIG. 7, more than 99% of the mercury was adsorbed onto each of the samples within six minutes.

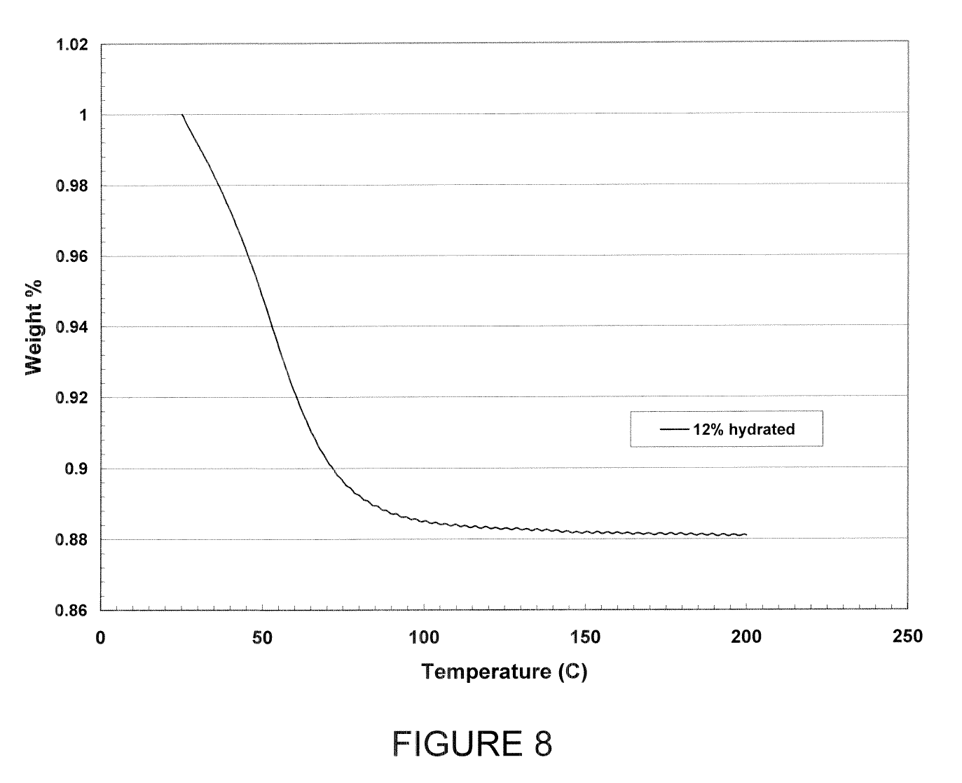

The mercury adsorption kinetics tests of Sample 1 were also carried out in base solution (the initial Hg concentration was 50 ppb and the pH was adjusted using NaOH). As shown in FIG. 8, the adsorbent has the ability to adsorb mercury even at pHs of higher than 12.

While the foregoing description has set forth the various embodiments of the present invention in particular detail, it must be understood that numerous modifications, substitutions and changes can be undertaken without departing from the true spirit and scope of the present invention as defined by the ensuing claims. The invention is therefore not limited to specific preferred embodiments as described, but is only limited as defined by the following claims.

We claim:

1. An adsorbent, comprising:
an absorbent support; and
one or more functional groups chemically attached to the surface of the absorbent support, said functional group or groups adapted to adsorb one or more targeted compounds.

2. The adsorbent of claim 1, wherein the absorbent support is precipitated silica.

3. The adsorbent of claim 2, wherein the precipitated silica has a specific surface area larger than 200 m²/g.

4. The adsorbent of claim 2, wherein the precipitated silica has a specific surface area larger than 400 m²/g.

5. The adsorbent of claim 2, wherein the precipitated silica has a pore volume larger than 0.3 ml/g.

6. The adsorbent of claim 2, wherein the precipitated silica has a pore volume larger than 0.8 ml/g.

7. The adsorbent of claim 2, wherein the precipitated silica has an average pore diameter larger than 100 Å.

8. The adsorbent of claim 2, wherein the precipitated silica has an average pore diameter larger than 150 Å.

9. The adsorbent of claim 2, wherein the precipitated silica has a particle size larger than 5 microns.

10. The adsorbent of claim 2, wherein the precipitated silica has a particle size larger than 10 microns.

11. The adsorbent of claim 2, wherein the precipitated silica has macropores.

12. The adsorbent of claim 1, wherein the functional group or groups adsorb targeted compounds chemically.

13. The adsorbent of claim 1, wherein the functional group comprises a thiol group.

14. An adsorbent, comprising:
an absorbent support, the support comprising precipitated silica having macropores, a specific surface area larger than 200 m²/g, a pore volume larger than 0.3 ml/g, and an average pore diameter larger than 100 Å; and
one or more functional groups chemically attached to the surface of the absorbent support, said functional group or groups adapted to adsorb one or more targeted compounds.

15. A method of producing an adsorbent composition comprising one or more functional groups attached to the surface of precipitated silica, comprising the steps of:
hydrating the precipitated silica to control water content; and
attaching one or more functional groups to the surface of said precipitated silica.

16. The method of claim 15, wherein the step of attaching one or more functional groups comprises the step of adding precursors comprising said functional groups and at least one reaction solvent to the precipitated silica under reaction conditions.

17. The method of claim 16, wherein said reaction solvent comprises carbon dioxide.

18. The method of claim 17, wherein the carbon dioxide is in a supercritical state.

19. The composition of claim 18, wherein said supercritical state is produced by a pressure higher than 6,000 psi and a temperature not lower than 90° C.

20. A method to remove a heavy metal from a solution, comprising the steps of:
placing an adsorbent composition in contact with the solution containing the heavy metal under conditions wherein said heavy metal is adsorbed by the adsorbent composition,
wherein said adsorbent composition comprises one or more functional groups chemically attached to the surface of precipitated silica, said functional group or groups adapted to adsorb the heavy metal.

21. The method of claim 20, wherein the heavy metal is mercury.

22. The method of claim 20, wherein said adsorbent composition has a mercury loading capacity of at least 0.2 g Hg/g adsorbent.

23. The method of claim 20, wherein more than 90% of the heavy metal is removed within six minutes from contacting said adsorbent composition.

24. The method of claim 20, wherein said solution has a pH greater than 10.
